(19) United States
(12) Patent Application Publication
(10) Pub. No.: US 2023/0147849 A1
(43) Pub. Date: May 11, 2023

(54) CHANGE OF OPERATING MODE

(71) Applicant: HEWLETT-PACKARD DEVELOPMENT COMPANY, L.P., SPRING, TX (US)

(72) Inventors: SHIH-HENG CHEN, TAIPEI CITY (TW); HSIANG-TA KE, TAIPEI CITY (TW); SHIH-HSIUNG TU, TAIPEI CITY (TW); HENG-CHANG HSU, TAIPEI CITY (TW)

(21) Appl. No.: 17/996,153

(22) PCT Filed: Apr. 29, 2020
(86) PCT No.: PCT/US20/30381

§ 371 Date: Oct. 13, 2022

(51) Int. Cl. H02J 50/10; H02J 50/80; H02J 50/90; G06F 1/3296; G06F 13/20

(52) U.S. Cl. CPC H02J 50/10; H02J 50/80; H02J 50/90; G06F 1/3296; G06F 13/20

(57) ABSTRACT

Examples of computing devices for changing an operating mode thereof are described herein. In an example, a signal is received by the computing device from an electronic device having a contactless reader. The electronic device is connectable to the computing device. The computing device Is operated in one of a low-power operating mode and a full-power operating mode based on the received signal.

### BACKGROUND

Computing devices, such as laptops, desktop computers, or All-In-One desktops may include power buttons to power ON the computing devices.

### BRIEF DESCRIPTION OF FIGURES

The detailed description is provided with reference to the accompanying figures, wherein:

FIG. 1 illustrates an electronic device for changing an operating mode of a computing device connectable to the electronic device, according to an example;

FIG. 2 illustrates a system environment, including an electronic device, a computing device, and a wireless communication device, for changing an operating mode of the computing device, according to an example;

FIG. 3 illustrates a computing device for changing an operating mode thereof, according to an example;

FIG. 4 illustrates a system environment, including a computing device, an electronic device, and a wireless communication device, for changing an operating mode of the computing device, according to an example; and

FIG. 5 illustrates a system environment using a non-transitory computer-readable medium for changing an operating mode of a computing device, according to an example.

### DETAILED DESCRIPTION

A power button of a computing device is generally operated, for example pressed, to power ON the computing device. The powering ON of the computing device supplies power signals to components of the computing device. In addition to powering ON, the power button of the computing device may be pressed to switch an operating mode of the computing device from a low-power operating mode, such as a sleep mode or a hibernation mode to a full-power operating mode. The power button of the computing device may be manually pressed by a user of the computing device for the purpose of switching the operating mode of the computing device. Such a manual press of the power button is an action performed by the user of the computing device.

The present subject matter describes example computing devices in which an operating mode of the computing device may be changed from a low-power operating mode to a full-power operating mode without a manual pressing of the power button of the computing device by a user.

In an example, the computing device includes an Input/Output (I/O) port, for example a wired I/O port or a wireless I/O port, and a processor coupled to the I/O port. The I/O port may connect the computing device to an electronic device having a contactless reader in a wired manner or wirelessly. The electronic device may include a docking station or a port replicator. The contactless reader of the electronic device monitors a proximity of a wireless communication device, such as a smart phone, a tablet, a phablet, a personal digital assistant (PDA), or a laptop computer, with respect to the electronic device.

The proximity of the wireless communication device to the electronic device, connected to the computing device, may be indicative of the user of the wireless communication device being in the vicinity of the computing device and is willing to use the computing device. The processor of the computing device may receive a signal, from the electronic device, indicative of the proximity of the wireless communication device to the electronic device. In an example, the computing device receives the signal via the I/O port. Further, the processor may operate the computing device in one of a low-power operating mode and a full-power operating mode depending on the signal received from the electronic device. The low-power operating mode may be one of a sleep mode, a hibernation mode, and a shutdown mode. The full-power operating mode is a mode, in which all the components of the computing device are powered ON.

In an example, in case the computing device is operating in the low-power operating mode and the received signal is indicative of the wireless communication device determined, by the contactless reader of the electronic device, to be in proximity of the electronic device, the processor of the computing device may switch an operating mode of the computing device from the low-power operating mode to the full-power operating mode. The processor of the computing device may keep operating the computing device in the low-power operating mode until the contactless reader determines that the wireless communication device is in proximity to the electronic device.

After the change of the operating mode of the computing device to the full-power operating mode, the processor of the computing device may continuously monitor the operational activity of the computing device. In case the computing device is idle for an idle time threshold based on the monitoring, the processor may change the operating mode of the computing device from the full-power operating mode to the low-power operating mode.

Accordingly, the computing devices of the present subject matter facilitate in switching of the operating mode of the computing device from the low-power operating mode to the full-power operating mode based on proximity of the wireless communication devices with respect to the computing devices, thus eliminating a manual action or effort from users of the computing devices to power ON the computing devices, such as resuming the full-power operating mode from the low-power operating mode, such as sleep mode.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof. It is to be noted that drawings of the present subject matter shown here are for illustrative purposes and are not drawn to scale.

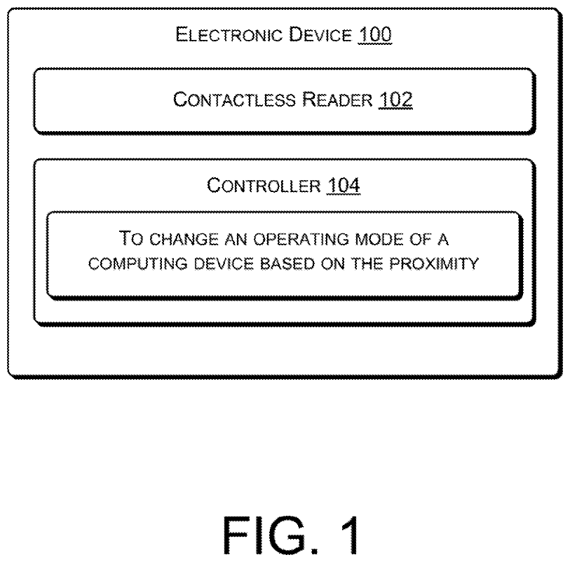

FIG. 1 illustrates an electronic device 100 for changing an operating mode of a computing device (not shown in FIG. 1) connectable to the electronic device 100, according to an example. Examples of the electronic device 100 may include, but are not limited to, a docking station and a port replicator.

The electronic device 100 includes a contactless reader 102 that may determine whether a wireless communication device (not shown in FIG. 1) is in proximity to the electronic device 100. The wireless communication device may be a smart phone, a tablet, a phablet, a personal digital assistant (PDA), or a laptop computer. The contactless reader 102 is a device for a wireless communication between the electronic device 100 and the wireless communication device. Examples of the contactless reader 102 may include, but are not limited to, a Near-Field Communication (NFC) based device, a Wi-Fi link based device, and a Bluetooth communication based device. The contactless reader 102 of the electronic device 100 may communicate with the wireless communication device to determine that the wireless communication device is in proximity to the electronic device 100. The wireless communication device is considered to be in proximity to the electronic device 100 if the wireless communication device exchanges signals with the contactless reader 102 of the electronic device 100.

The electronic device 100 further includes a controller 104 that is coupled to the contactless reader 102 of the electronic device 100. The controller 104 is to receive information from the contactless reader 102 when the wireless communication device is determined to be in proximity to the electronic device 100. The information is in a form of a proximity signal. In addition, the controller 104 may handle various tasks of the electronic device 100.

In response to determination by the controller 104, based on the information from the contactless reader 102, that the wireless communication device is in proximity to the electronic device 100, the controller 104 transmits a power signal to the computing device. The computing device is connectable to the electronic device 100. The computing device may be a desktop computer, a tablet, a laptop computer, or an All-In-One desktop. The transmitted power signal is a signal that may induce a power supply for powering ON the components of the computing device, which are in OFF-state. In an example, the computing device is connectable to the electronic device 100 via a Universal Serial Bus (USB)-Type-C cable. The information that the wireless communication device is in proximity to the electronic device 100 is indicative of presence of a user of the wireless communication device in vicinity of the computing device.

The computing device, on receiving the power signal from the controller 104 of the electronic device 100, changes an operating mode thereof from a low-power operating mode to a full-power operating mode. In the low-power operating mode, such as a sleep mode, a hibernation mode or a shutdown mode, specific components of the computing device are not supplied with power signals in order to avoid unnecessary operation of all the components of the computing device. When the operating mode of the computing device changes to the full-power operating mode, all the components of the computing device may be supplied with power signals. Thus, the electronic device 100 by changing the operating mode of the computing device to the full-power operating mode provides full functional features for a user to use.

The signal pertaining to the proximity of the wireless communication device with the electronic device 100 enables change of the operating mode of the computing device from the low-power operating mode to the full-power operating mode. Thus, the electronic device 100 eliminates a manual action which is otherwise carried out from the user to change the operating mode of the computing device or to power ON the computing device.

Although, the change of the operating mode of the computing device from the low-power operating mode to the full-power operating mode is explained with respect to the controller 104, the operating mode of the computing device can be changed by any other controller or microprocessor of the electronic device 100, which is separate from the controller 104 of the electronic device 100.

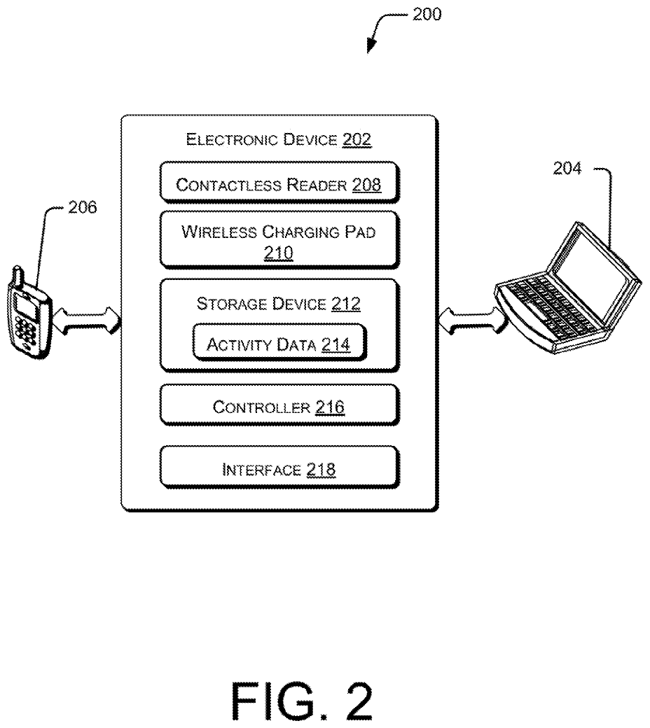

FIG. 2 illustrates a system environment 200 using an electronic device 202, a computing device 204, and a wireless communication device 206 for changing an operating mode of the computing device 204, according to an example. In an example, the electronic device 202 may be similar to the electronic device 100 of FIG. 1.

The electronic device 202 includes a contactless reader 208 similar to the contactless reader 102. In an example, the contactless reader 208 communicates with the wireless communication device 206 to determine whether the wireless communication device 206 is in proximity to the electronic device 202. The wireless communication device 206 is a device that transmits a signal to another communication device and receives a signal from the other communication device or vice-versa. In an example, the wireless communication device 206 may be wirelessly chargeable. Examples of the wireless communication device 206 may include, but are not limited to, a smart phone, a tablet, a phablet, a personal digital assistant (PDA), and a laptop computer.

In an example, the electronic device 202 includes a wireless charging pad 210 to wirelessly charge a battery (not shown) of the wireless communication device 206. The wireless charging pad 210 is a device that may charge a wirelessly chargeable device using electromagnetic induction. When the wireless communication device 206 is placed on the wireless charging pad 210, the contactless reader 208 communicates with the wireless communication device 206 to determine that the wireless communication device 206 is in proximity to the electronic device 202. Therefore, the wireless charging pad 210 within the electronic device 202 having a docking function can charge the battery of the wireless communication device 206. Thus, integration of the wireless charging function and the docking function minimizes cable routing within the system environment 200.

Further, the electronic device 202 includes a storage device 212. In an example, the storage device 212 may be a non-volatile memory, a volatile memory or a combination of both. Examples of the non-volatile memory may include, but are not limited to read only memory (ROM), erasable programmable ROM, flash memories, hard disks, optical disks, and magnetic tapes. The volatile memory may include any non-transitory computer-readable medium known in the art including, such as static random-access memory (SRAM) and dynamic random-access memory (DRAM). In an example, the storage device 212 may be a shared memory, such that the storage device 212 may be simultaneously accessible by multiple applications and devices. The storage device 212 may store an activity data 214. In an example, the activity data 214 may include the signal associated with the determined proximity of the wireless communication device 206 to the electronic device 202, a power signal, a user authorization signal, and a charging signal. The signal associated with the determined proximity of the wireless communication device 206 to the electronic device 202 relates to the presence of a user (not shown) near the electronic device 202 and the computing device 204.

The electronic device 202 further includes a controller 216 that may be coupled to the contactless reader 208, the wireless charging pad 210, and the storage device 212 of the electronic device 202. The controller 216 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labeled as “controller(s)”, may be provided through the use of dedicated hardware as well as hardware capable of executing computer-readable instructions.

In an example, the contactless reader 208, the wireless charging pad 210, the storage device 212, and the controller 216 may be coupled to the electronic device 202 by means of an interface 218. The interface 218 facilitates the communication between the contactless reader 208, the wireless charging pad 210, the storage device 212, and the controller 216.

The controller 216 of the electronic device 202 may transmit a power signal to the computing device 204 to change an operating mode of the computing device from the low-power operating mode to a full-power operating mode in a similar manner and similar condition as performed by the controller 104 of FIG. 1. The computing device 204 may be a desktop computer, a tablet, a laptop computer, etc.

Further, the controller 216 may transmit a charging signal to the wireless charging pad 210 to charge the battery of the wireless communication device 206. The charging signal is transmitted from the controller 216 to the wireless charging pad 210 when the wireless communication device 206 is placed on the the wireless charging pad 210. In an example, the wireless charging pad 210 may include a detection circuit (not shown) to detect whether the wireless communication device 206 is placed on the wireless charging pad 210. The detection circuit may include a transmitter coil which may keep sending magnetic waves of low magnitude to the environment in vicinity of the wireless charging pad 210. When a receiver coil (not shown) of the the wireless communication device 206 receives the magnetic waves from the transmitter coil of the detection circuit, the wireless communication device 206 is detected to be placed on the wireless charging pad 210.

The controller 216 may transmit the power signal and the charging signal simultaneously so that the battery of the wireless communication device 206 is charged and, at the same time, the operating mode of the computing device 204 changes from the low-power operating mode to the full-power operating mode.

While the wireless communication device 206 is communicating with the contactless reader 208 of the electronic device 202, the controller 216 of the electronic device 202 may obtain the user authorization signal from the wireless communication device 206. The user authorization signal is a signal having user credentials for a secure login to a device. After receiving the user authorization signal from the wireless communication device 206, the controller 216 of the electronic device 202 may transmit the received user authorization signal to the computing device 204. The computing device 204 on receiving the user authorization signal may check the validity of the user authorization signal. If the user authorization signal is validated by the computing device 204, a login of a user of the wireless communication device 206 may be authorized to the computing device 204. Therefore, the wireless communication device 206 may enable logging into the computing device 204 on behalf of the user of the wireless communication device 206 when the wireless communication device 206 is coupled to the electronic device 202. In an example, the wireless communication device 206 may be a standalone device used primarily for logging the user into the computing device 204.

In the system environment 200, by placing the wireless communication device 206 on the wireless charging pad 210 of the electronic device 202, i.e. when the wireless communication device 206 is in proximity to the electronic device 202, i.e., the operating mode of the computing device 204 may be changed, the battery of the the wireless communication device 206 may be charged, and the user of the wireless communication device 206 logs into the computing device 204.

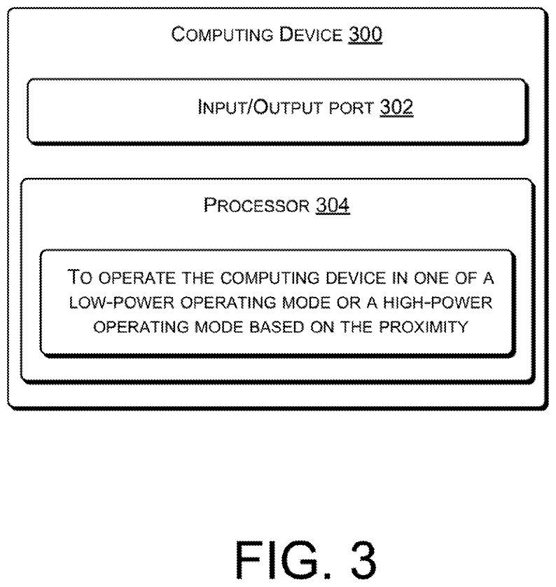

FIG. 3 illustrates a computing device 300 for changing an operating mode thereof, according to an example. Examples of the computing device 300 may include, but are not limited to, a laptop, a notebook computer, a smart phone, a tablet, and All-In-One desktop.

The computing device 300 includes an Input/Output (I/O) port 302. The I/O port 302 is an interface that connects the computing device 300 with an external device either in a wired manner or wirelessly. Examples of the I/O port 302 may include a wired I/O port or a wireless I/O port. In an example, the I/O port 302 connects the computing device 300 to an electronic device (not shown in FIG. 3) having a contactless reader (not shown in FIG. 3). In an example, the contactless reader, such as a Near Field Communication reader of the electronic device, such as a docking station may determine a proximity of a wireless communication device to the electronic device. The wireless communication device may be one of a smart phone, a tablet, a phablet, a personal digital assistant (PDA), and a laptop computer.

The computing device 300 further includes a processor 304. The processor 304 is coupled to the I/O port 302, which connects the processor 304 to the electronic device so that the processor 304 may communicate with the electronic device. In response to the communication of the processor 304 with the electronic device, the processor 304 receives a signal from the electronic device via the I/O port 302. The signal from the electronic device may be indicative of the proximity of the wireless communication device to the electronic device.

The processor 304, in response to the signal received from the electronic device, may determine an operating mode, in which the computing device is to be operated and operate the computing device in the determined operating mode. The operating mode may be one of a low-power operating mode and a full-power operating mode. In an example, in case the signal received by the processor 304 indicates that the wireless communication device is in proximity to the electronic device and the computing device 300 is operating in the low-power operating mode, the processor 304 of the computing device 300 switches the operating mode of the computing device 300 from the low-power operating mode to the full-power operating mode. The full-power operating mode is a mode in which all the components of the computing device 300 may be powered ON. On the other hand, the low-power operating mode is a power-saving operating mode in which specific components of the computing device 300 may be powered ON.

The processor 304 of the computing device 300 operates in the operating mode, such as the low-power operating mode or the full-power operating mode based on the proximity of the wireless communication device to the electronic device. Thus, a manual intervention to select or switch the operating mode of the computing device 300 is eliminated.

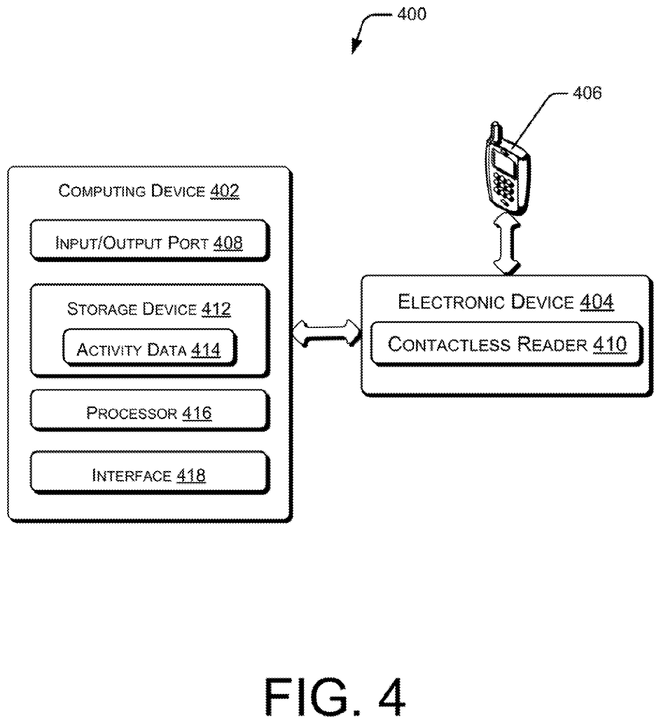

FIG. 4 illustrates a system environment 400 including a computing device 402, an electronic device 404, and a wireless communication device 406 for changing an operating mode of the computing device 402, according to an example. The computing device 402 may be similar to the computing device 300 and may be one of a laptop, a notebook computer, an All-In-One desktop, and a tablet.

The computing device 402 includes an Input/Output (I/O) port 408 similar to the Input/Output (I/O) port 302 of FIG. 3. The I/O port 408 provides a communication channel between the computing device 402 and the electronic device 404 connectable to the computing device 402. In one example, the computing device 402 may receive information from the electronic device 404 via the I/O port 408. The information may include a signal indicative of a proximity of the wireless communication device 406 to the electronic device 404. In an example, the proximity of the wireless communication device 406 to the electronic device 404 may be determined by a contactless reader 410 of the electronic device 404, which may be similar to the contactless reader 102 and the contactless reader 208.

Examples of the I/O port 408 may include, but is not limited to, a wired I/O port and a wireless I/O port. In case the I/O port 408 is the wired I/O port, the computing device 402 may be connected to the electronic device 404 via a data cable compatible to the I/O port 408. The wired I/O port may be a Universal Serial Bus (USB) port, an Ethernet port, or a Local Area Network (LAN) port. In case the wired I/O port is the USB port, the computing device 402 may be connected to the electronic device 404 via a USB Type-C cable. In an example, if the electronic device 404 has a wireless charging capability to charge the wireless communication device 406, the USB Type-C cable can draw power signals from the computing device 402 to further supply the power signals to the electronic device 404 for charging the wireless communication device 406. Simultaneously, the USB Type-C cable can exchange data between the computing device 402 and the electronic device 404.

In case the I/O port 408 is the wireless I/O port, the computing device 402 may be connected to the electronic device 404 via a wireless link compatible to the I/O port 408. The wireless link may be one of a Near Field Communication (NFC) link, a Bluetooth link, and a Wi-Fi link.

Further, the computing device 402 includes a storage device 412. In an example, the storage device 412 may be a non-volatile memory, a volatile memory, or a combination of both. Examples of the non-volatile memory may include, but are not limited to read only memory (ROM), erasable programmable ROM, flash memories, hard disks, optical disks, and magnetic tapes. The volatile memory may include any non-transitory computer-readable medium known in the art including, such as static random-access memory (SRAM) and dynamic random-access memory (DRAM). In an example, the storage device 412 may be a shared memory, such that the storage device 412 may be simultaneously accessible by multiple applications and devices.

The storage device 412 may store an activity data 414. In an example, the activity data 414 may include the information from the electronic device 404 including the signal associated with the determined proximity of the wireless communication device 406 to the electronic device 404, an idle time duration, an idle time threshold, and a user authorization signal. In an example, the signal associated with the determined proximity of the wireless communication device 406 to the electronic device 404 may change dynamically. In an example, the idle time threshold changes when a user of the computing device 402 resets the idle time threshold to a new value. Similarly, the user authorization signal may be periodically changed by the user of the computing device 402 to keep the computing device 402 safe from unauthorized login. The signal associated with the determined proximity of the wireless communication device 406 to the electronic device 404 relates to the presence of a user of the wireless communication device 406 near the electronic device 404 and the computing device 402.

Further, the computing device 402 includes a processor 416 coupled to the I/O port 408 and the storage device 412. The processor 416 may be similar to the processor 304 of FIG. 3. In an example, the processor 324 may receive the signal associated with the proximity of the wireless communication device 406 to the electronic device 404 via the I/O port 408 of the computing device 402. The signal is generated in the electronic device 404 by the action of the contactless reader of the electronic device 404 and further transmitted to the computing device 402.

The processor 416 analyses the received signal to determine whether the wireless communication device 406 is in proximity to the electronic device 404. In case the received signal, based on the analysis, is indicative of the wireless communication device 406 to be in proximity to the electronic device 404 and the computing device 402 is operating in a low-power operating mode, the processor 416 switches an operating mode of the computing device 402 from the low-power operating mode to a full-power operating mode without a manual intervention.

In case the computing device 402 is operating in the full-power operating mode and simultaneously the processor 416 receives the signal indicative of the wireless communication device 406 to be in proximity to the electronic device 404, the processor 416 keeps the computing device 402 to operate in the full-power operating mode.

In case, in an example, when the processor 416 of the computing device 402 determines that the computing device 402 is idle for the idle time threshold, the processor 416 may switch the operating mode from the full-power operating mode to the low-power operating mode. Thus, the processor 416 operates the computing device 402 in the full-power operating mode until determining that the computing device 402 is idle for the idle time threshold.

The computing device 402 is switched to the low-power operating mode, since the low-power operating mode is a power-saving operating mode that saves unnecessary expense of power signals to the components of the computing device 402. The power-saving operating mode may include one of a sleep mode, a hibernation mode, and a shutdown mode. The operating mode of the computing device 402 may be switched from the full-power operating mode to one of the sleep mode, the hibernation mode, and the shutdown mode depending on the settings of the computing device 402. In an example, the idle time threshold may be pre-set by the user of the computing device 402. In an example, the processor 416 may cause a system service to run in background to continuously determine the idle time duration, during which the processor 416 is inactive.

The I/O port 408, the storage device 412, and the processor 416 are coupled to the computing device 402 by means of an interface 418. The interface 418 facilitates the communication between the I/O port 408, the storage device 412, and the processor 416.

In an example, the user of the computing device 402 may override the processor 416 action that controls the change of the operating mode of the computing device 402 in case the computing device 402 is idle for the idle time threshold but the user is in vicinity of the computing device 402.

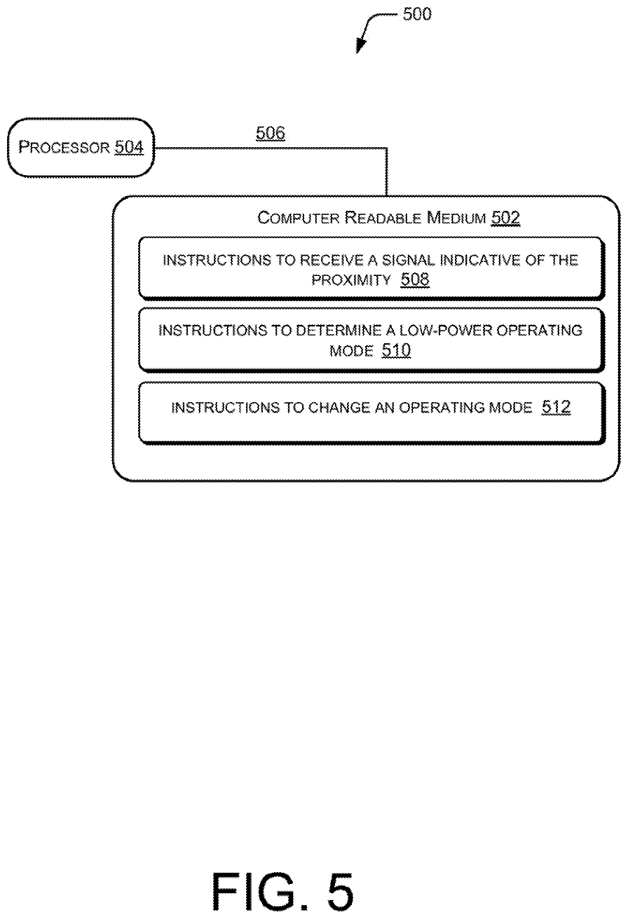

FIG. 5 illustrates a system environment 500 using a non-transitory computer-readable medium 502 for changing an operating mode of a computing device, according to an example. The system environment 500 includes a processor 504 communicatively coupled to the non-transitory computer-readable medium 502 through a communication link 506 for fetching and executing computer-readable instructions from the non-transitory computer-readable medium 502.

The non-transitory computer-readable medium 502 may be, for example, an internal memory device or an external memory device. In one example, the communication link 506 may be a direct communication link, such as one formed through a memory read/write interface. In another example, the communication link 506 may be an indirect communication link, such as one formed through a network interface. In such a case, the processor 504 may access the non-transitory computer-readable medium 502 through a network (not shown).

In an example, the non-transitory computer-readable medium 502 includes a set of computer-readable and executable instructions for changing the operating mode of the computing device. The set of computer-readable instructions may include instructions as explained in conjunction with FIGS. 3 and 4. The set of computer-readable instructions, referred to as instructions hereinafter, may be accessed by the processor 504 through the communication link 506 and subsequently executed to perform acts for changing the operating mode of the computing device.

Referring to FIG. 5, in an example, the non-transitory computer-readable medium may include instructions 508 that cause the processor 504 to receive a signal indicative of a proximity of a wireless communication device to the computing device. The signal indicative of the proximity of the wireless communication device to the computing device is received from a contactless reader, such as the contactless reader 410 of the electronic device 404 connectable to the computing device 402. The signal may be an indicative that a user of the wireless communication device is willing to use the computing device. In an example, the signal may be received by the processor 504 via an Input/Output (I/O) port, via which the contactless reader is connected to the computing device. In an example, the contactless reader can detect the proximity of the wireless communication device to the electronic device if the wireless communication device is present at a distance of less than 10 meters from the contactless reader. In case, the contactless reader is a Near Field Communication (NFC) based device, the contactless reader can detect the proximity of the wireless communication device if the wireless communication device is present at a distance of less than 1 meter from the contactless reader. The value of the distance of the wireless communication device from the contactless reader can be preset based on user preference or can be dependent on the type of the contactless reader, such as Near Field Communication (NFC) based device or the Bluetooth based device.

The non-transitory computer-readable medium 502 may also include instructions 510 to further cause the processor 504 to determine whether the computing device is operating in a low-power operating mode. Operating in the low-power operating mode may be indicative of the computing device operating in a power-saving operating mode, in which specific components of the computing device are not supplied with power signals. In case the processor 504 determines that the computing device is operating in a full-power operating mode, the processor 504 keep an operating mode of the computing device unchanged.

The non-transitory computer-readable medium 502 may include further instructions 512 to cause the processor 504 to change the operating mode of the computing device from the low-power operating mode to the full-power operating mode on receiving the signal that the wireless communication device is in proximity to the computing device and determining that the computing device is operating in the low-power operating mode. The change of the operating mode of the computing device is performed based on the proximity signal, thereby eliminating a manual intervention from the user. The change of the operating mode from the from the low-power operating mode to the full-power operating mode is to ensure that all the components of the computing device are powered ON or supplied with the power signals.

The non-transitory computer-readable medium 502 may include further instructions to cause the processor 504 to change the operating mode of the computing device from the full-power operating mode to the low-power operating mode. The operating mode of the computing device is changed in response to determining that the computing device is idle for an idle time threshold. To determine that the computing device is idle for the idle time threshold, the processor 504 continuously monitors operational activities of the computing device. In case the computing device is idle or operationally inactive, the processor 504 triggers a time clock to calculate an idle time duration during which the computing device is idle. Further, the processor 504 keeps comparing the calculated idle time duration with the idle time threshold and changes the operating mode of the computing device from the full-power operating mode to the low-power operating mode on determining that the calculated idle time duration exceeds the idle time threshold. In an example, the idle time threshold can be set by the user and can be updated based on user preference. In an example, the idle time threshold may be 10 minutes.

The non-transitory computer-readable medium 502 may include further instructions to cause the processor 504 to obtain a user authorization signal from the wireless communication device for a communication of the contactless reader with the wireless communication device. In an example, the wireless communication device may be emulated by the contactless reader as a contactless smart card. The user authorization signal may include user credentials for authenticating a secure login to the computing device. The processor 504, on receiving the user authorization signal, may check the validity of the user authorization signal. In case the user authorization signal is validated by the processor 504 of the computing device, the non-transitory computer-readable medium 502 may include further instructions to cause the processor 504 to authorize a login of a user of the wireless communication device to the computing device based on the user authorization signal validated by the processor 504.

Although aspects for the present disclosure have been described in a language specific to structural features and/or methods, it is to be understood that the appended claims are not limited to the specific features or methods described herein. Rather, the specific features and methods are disclosed as examples of the present disclosure.

We claim:

1. An electronic device comprising:
a contactless reader to determine whether a wireless communication device is in proximity to the electronic device; and
a controller coupled to the contactless reader to:
in response to determining that the wireless communication device is in proximity to the electronic device, transmit a power signal to a computing device, connectable to the electronic device, to change an operating mode of the computing device from a low-power operating mode to a full-power operating mode.

2. The electronic device as claimed in claim 1, wherein the electronic device comprises:
a wireless charging pad coupled to the controller to charge a battery of the wireless communication device,
wherein the controller is to transmit a charging signal to the wireless charging pad to charge the battery of the wireless communication device.

3. The electronic device as claimed in claim 1, wherein the controller is to further:
obtain a user authorization signal from the wireless communication device; and
transmit the user authorization signal to the computing device to authorize a login of a user of the wireless communication device to the computing device.

4. The electronic device as claimed in claim 1, wherein the contactless reader is a Near-Field Communication (NFC) based device.

5. The electronic device as claimed in claim 1, wherein the contactless reader is a Bluetooth communication based device.

6. The electronic device as claimed in claim 1, wherein the low-power operating mode is one of a sleep mode, a hibernation mode, and a shutdown mode.

7. A computing device comprising:
an Input/Output (I/O) port to connect the computing device to an electronic device having a contactless reader; and
a processor coupled to the I/O port to:
receive, via the I/O port, a signal from the electronic device, the signal being indicative of a proximity of a wireless communication device to the electronic device; and
operate the computing device in one of a low-power operating mode and a full-power operating mode based on the received signal.

8. The computing device as claimed in claim 7, wherein the processor is to switch an operating mode of the computing device from the low-power operating mode to the full-power operating mode in response to the received signal being indicative of the wireless communication device in proximity to the electronic device.

9. The computing device as claimed in claim 8, wherein the processor is to operate the computing device in the full-power operating mode until determining that the computing device is idle for an idle time threshold.

10. The computing device as claimed in claim 7, wherein the low-power operating mode is a power-saving operating mode including one of a sleep mode, a hibernation mode, and a shutdown mode.

11. The computing device as claimed in claim 7, wherein the I/O port is one of a wired I/O port and a wireless I/O port.

12. The computing device as claimed in claim 11 herein the wired I/O port is a Universal Serial Bus (USB) port.

13. A non-transitory computer-readable medium comprising computer-readable instructions, which, when executed by a processor of a computing device, cause the processor to:
receive, from a contactless reader, a signal indicative of a proximity of a wireless communication device to the computing device;
determine whether the computing device is in a low-power operating mode; and
in response to receiving the signal and determining that the computing device is in the low-power operating mode, change an operating mode of the computing device from the low-power operating mode to a full-power operating mode.

14. The non-transitory computer-readable medium as claimed in claim 13, wherein the computer-readable instructions cause the processor to change the operating mode of the computing device from the full-power operating mode to the low-power operating mode in response to determining that the computing device is idle for an idle time threshold.

15. The non-transitory computer-readable medium as claimed in claim 13, wherein the computer-readable instructions cause the processor to:
obtain a user authorization signal from the wireless communication device for a communication of the contactless reader with the wireless communication device; and
authorize a login of a user of the wireless communication device to the computing device based on the user authorization signal.
